(19) United States
(12) Patent Application Publication
(10) Pub. No.: US 2025/0176472 A1
(43) Pub. Date: Jun. 5, 2025

(54) METHOD AND APPARATUS FOR TRAINING LIMBS

(71) Applicant: BENDIES LLC, Albuquerque, NM (US)

(72) Inventor: Brendan Mead, Albuquerque, NM (US)

(73) Assignee: BENDIES LLC, Albuquerque, NM (US)

(21) Appl. No.: 18/760,847

(22) Filed: Jul. 1, 2024

Related U.S. Application Data
(60) Provisional application No. 63/604,375, filed on Nov. 30, 2023.

(51) Int. Cl. A01G 7/06

(52) U.S. Cl. CPC A01G 7/06

(57) ABSTRACT

A method and apparatus for training plant limbs. The plant limb training apparatus has a first plate and a second plate. The first plate has a bar extending from a first fulcrum portion and a first support arm at the distal end, and the second plate has a second support arm extending from the distal end and a hole for the bar to fit into when the second plate is disposed on the first plate. The second plate has a partial gear on the fulcrum portion. A pin extending from the first support arm fits into the partial gear, thus securing the position of the first plate and the second plate, while allowing the two plates to rotate. The plant limb training apparatus may also have only one plate in a curved shape, with three arms, at least two of which have steps.

### CROSS-REFERENCE TO RELATED APPLICATIONS

This application claims the benefit of U.S. Provisional Patent Application Ser. No. 63/604,375 filed Nov. 30, 2023, titled “METHOD AND APPARATUS FOR TRAINING LIMBS,” and the subject matter thereof is incorporated herein by reference thereto.

### TECHNICAL FIELD

The present disclosure relates to a support system for plant limbs, and more specifically, to an adjustable plant limb training apparatus.

### PRIOR ART

When growing plants, people use different types of training or support devices that allow for the limbs to be trained (i.e., direction of growth). These devices can help manage the spacing of limbs/branches to maximize airflow and light penetration.

Plant limb support apparatuses and systems are present in the prior art. U.S. Pat. No. 11,452,267 to Pena discloses an adjustable limb training device comprised of two portions that act together to rotate and train plant limbs. US 2018/0249643 to Akana discloses a plant manipulator comprised of flexible cylindrical member that is bent to hold a plant in order to train the plant. US 20220394932 to Macey et al. discloses a plant limb training apparatus comprised of two portions attached at a fulcrum point.

The prior art plant training apparatuses have shortcomings. They are difficult to use, difficult to adjust, do not provide the adequate training of the limbs, etc. None of the prior art fully addresses the problems resolved by the present invention. The present invention overcomes these limitations contained in the prior art.

The present disclosure provides a plant limb training apparatus that is easy to use, easy to adjust, provides the appropriate level of support to limbs in order to train them, durable, and is inexpensive to produce.

With some of the prior art devices, they must be removed from the limbs in order to adjust the device. The present invention allows the user to adjust the rotation of the device while it is still in contact with the plant limbs. In one embodiment, the present invention has multiple steps on the arms to allow limbs to be adjusted without removing the present invention from a plant.

### BRIEF DESCRIPTION OF DRAWINGS

FIG. 1 illustrates a perspective view of the plant limb training apparatus of the present invention.

FIG. 2 illustrates a perspective view of the first plate of plant limb training apparatus of the present invention.

FIG. 3 illustrates a perspective view of the second plate of plant limb training apparatus of the present invention.

FIG. 4 illustrates a perspective back view of an alternate embodiment of the plant limb training apparatus of the present invention.

FIG. 5 illustrates a perspective front view of an alternate embodiment of the plant limb training apparatus of the present invention.

FIG. 6 illustrates a back side view of an alternate embodiment of the plant limb training apparatus of the present invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures, if any. The term “on” means that there is direct contact among elements.

The present invention provides a plant limb training apparatus, comprising: a first plate, wherein the first plate comprises a bar extending outward at a first fulcrum portion, wherein the first plate comprises a first support arm extending outward near the distal end of the first plate, wherein a pin is disposed on the first support arm extending partially toward the bar; and a second plate, wherein the second plate comprises a hole at a second fulcrum portion, wherein the second plate comprises a second support arm extending outward near the distal end of the second plate, wherein the rounded edge of the second plate near the second fulcrum portion comprises a partial gear, and wherein the bar of the first plate is disposed in the hole of the second plate thus creating a fulcrum point at the first and second fulcrum portions, and the pin on the first support arm is substantially close to the partial gear of the second plate.

The present invention further provides a plant limb training apparatus: wherein one or more nubs are disposed on the bar on the first plate; wherein the hole on the second plate comprises one or more notches in the shape of the one or more nubs on the bar on the first plate; wherein the pin is configured to rotationally engage the partial gear; wherein when the second plate is disposed on the first plate, the second plate rotates at the fulcrum point and is locked into place at each dedendum of the gear; wherein one or more additional support arms are disposed on the first plate and/or the second plate; wherein the first plate and the second plate are one solid piece; and wherein the bar and the first support arm each extend outward from the first plate at an approximately 90 degree angle, and the second support arm extends outward from the second plate at an approximately 90 degree angle.

The present invention further provides a plant limb training apparatus, comprising: a first plate and a second plate, wherein the first plate contains a first support arm extending outward near the distal end of the first plate, wherein the second plate contains a second support arm extending outward near the distal end of the second plate, wherein the edge of the second plate near the fulcrum point comprises a partial rounded gear, wherein the first plate and second plate are rotatably and axially connected at a fulcrum point, wherein the first plate contains a pin disposed on the first support arm that extends partially toward the fulcrum point; and wherein pin is substantially close to the partial gear of the second plate.

The present invention further provides a plant limb training apparatus: wherein one or more nubs are disposed on the bar on the first plate; wherein the hole on the second plate comprises one or more notches in the shape of the one or more nubs; wherein the pin is configured to rotationally engage the gear; wherein when the second plate is disposed on the first plate, the second plate rotates at the fulcrum point and is locked into place at each dedendum of the gear; wherein one or more additional support arms are disposed on the first plate and/or the second plate; wherein the first plate and the second plate are one solid piece; and wherein the bar and the first support arm each extend outward from the first plate at an approximately 90 degree angle, and the second support arm extends outward from the second plate at an approximately 90 degree angle.

The present invention further provides an alternate embodiment of a plant limb training apparatus, comprising: a curved plate with a flat surface; a first support arm; a second support arm; and a third support arm, wherein the first support arm, the second support arm, and the third support arm are disposed on the curved plate, with each support arm extending outward from the curved plate at an approximately 90 degree angle, wherein the first support arm and the third support arm are located near the ends of the curved plate, wherein the second support arm is located between the first support arm and the third support arm, and wherein the first support arm and the third support arm each have at least one step that creates at least one ledge.

The present invention further provides an alternate embodiment of a plant limb training apparatus: wherein the steps on the first support arm and the third support arm are oriented such that they partially face the second support arm; wherein the first support arm, the second support arm, and the third support arm each have an overhang at the distal ends; and wherein the first support arm and the third support arm each have an overhang on the ledges of the steps.

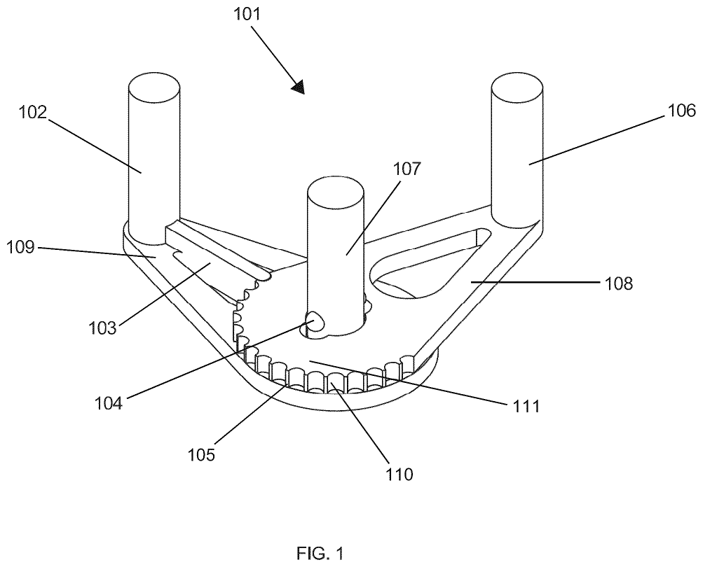

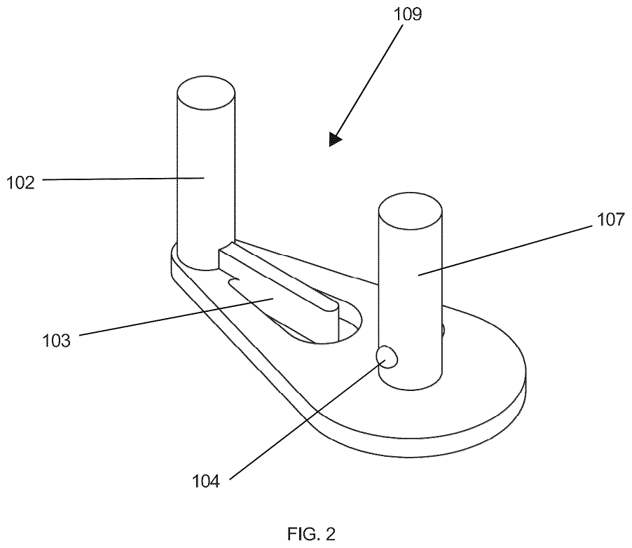

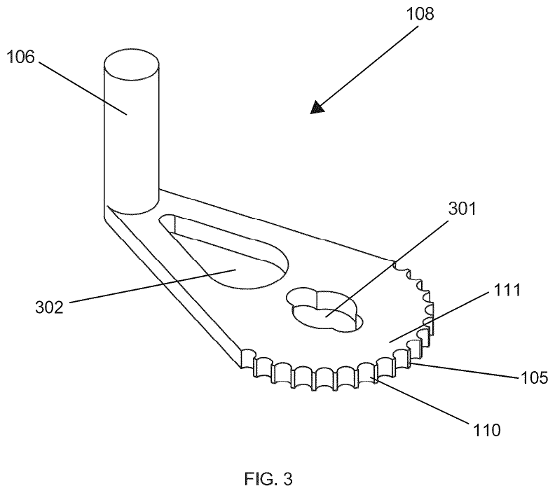

FIG. 1 shows a perspective view of plant limb training apparatus 101. Plant limb training apparatus 101 comprises first plate 109 and second plate 108. First plate 109 and second plate 108 are separate plates, as shown in FIGS. 2 and 3. Bar 107 is disposed on first plate 109 and extends outward at a first fulcrum portion. First support arm 102 is disposed on first plate 109 and extends outward near the distal end of first plate 109. Nub 104 is disposed on bar 107. Pin 103 is disposed on first support arm 102 and extends partially toward bar 107.

Hole 301 (as shown in FIG. 3) is disposed on second plate 108 at a second fulcrum portion. Second support arm 106 is disposed on second plate 108 and extends outward near the distal end of second plate 108. The rounded edge of second plate 108 near the second fulcrum portion comprises partial gear 111. Partial gear 111 comprises teeth 105, with spaces 110 between teeth 105 being shaped such that the distal end of pin 103 can securably fit in spaces 110. The distal end of pin 103 is substantially the same size and shape as spaces 110.

With respect to plant limb training apparatus 101, the distal end is defined as the end furthest from the first or second fulcrum portion. When second plate 108 is disposed on first plate 109, the second fulcrum portion and first fulcrum portion align, thus creating a fulcrum point of plant limb training apparatus 101.

FIG. 2 shows a perspective view of first plate 109 of plant limb training apparatus 101. Bar 107 is disposed on first plate 109 and extends outward at a first fulcrum portion. First support arm 102 is disposed on first plate 109 and extends outward near the distal end of first plate 109. Nub 104 is disposed on bar 107. Pin 103 is disposed on first support arm 102 and extends partially toward bar 107. Pin 103 is preferably rigid but may have a little flexibility.

FIG. 3 shows a perspective view of second plate 108 of plant limb training apparatus 101. Hole 301 is disposed on second plate 108 at a second fulcrum portion. The shape of hole 301 is such that when bar 107 is disposed in hole 301, nub 104 fits through hole 301. When first plate 109 is turned with respect to second plate 108, the position of nub 104 is such that it prevents second plate 108 from losing contact with first plate 109. Second hole 302 may or may not be present.

Bar 107 is inserted into hole 301, thus allowing second plate 108 to be securely and removably attached to first plate 109. Nub 104 secures bar 107 in place in hole 301. Pin 103 extends toward bar 107 such that the distal end of pin 103 fits in the spaces 110 in between the teeth 105 of partial gear 111. Pin 103 has rigidity such that it secures first plate 109 and second plate 108 together in the desired position and prevents second plate 108 from rotating.

Pin 103 has enough flexibility that it allows for second plate 108 to be rotated when in position on first plate 109. When second plate 108 is rotated, partial gear 111 rotates and pin 103 flexes and moves over teeth 105, which continues until the desired placement is achieved, at which point, pin 103 securably rests in the desired spaces 110.

In order to use plant limb training apparatus 101, first support arm 102 and second support arm 106 are adjusted accordingly to support and train the plant limbs. Plant limb training apparatus 101 can be adjusted by rotating first plate 109 with respect to second plate 108. This allows pin 103 to change its position with respect to partial gear 111. This changes the orientation of first support arm 102, bar 107, and second support arm 106, which allows the limb to change direction as desired and maintain support and contact with first support arm 102, second support arm 106, and/or bar 107, as needed.

Ideally, when plant limb training apparatus 101 is being used on a plant, plant limbs will be in contact with each of first support arm 102, second support arm 106, and bar 107 in order to train the limb. By making small adjustments by rotating first plate 109, this allows the plant limbs to be slowly moved (trained) and grow in the desired direction. Plant limb training apparatus 101 can be used to direct the growth of plant limbs as desired. Plant limb training apparatus 101 is lightweight and does not negatively affect the growth of the plant.

Any number of plant limb training apparatuses 101 may be utilized on a plant.

In alternate embodiments, any number of support arms are disposed on either first plate and/or second plate.

In alternate embodiments, additional plates may be part of plant limb training apparatuses 101, with all plates connecting at the fulcrum point. Any number of support arms may be disposed on the plates.

In alternate embodiments, the size of the plates are adjustable.

In alternate embodiments, multiple fulcrum points may be present, with multiple plates attached at difference fulcrum points.

In alternate embodiments, the fulcrum point may be at any position that provides the desired results.

The method of using plant limb training apparatus 101 is also provided herein. The method comprises the steps of adjusting first support arm 102 and second support arm 106 to be in direct contact with the intended plant limbs in the desired direction. Plant limb training apparatus 101 is adjusted by rotating first plate 109 with respect to second plate 108. This change the bend of the plant limb, as desired. The allows the limb to change direction as desired and maintain support and contact with first support arm 102, second support arm 106, and/or bar 107, as needed.

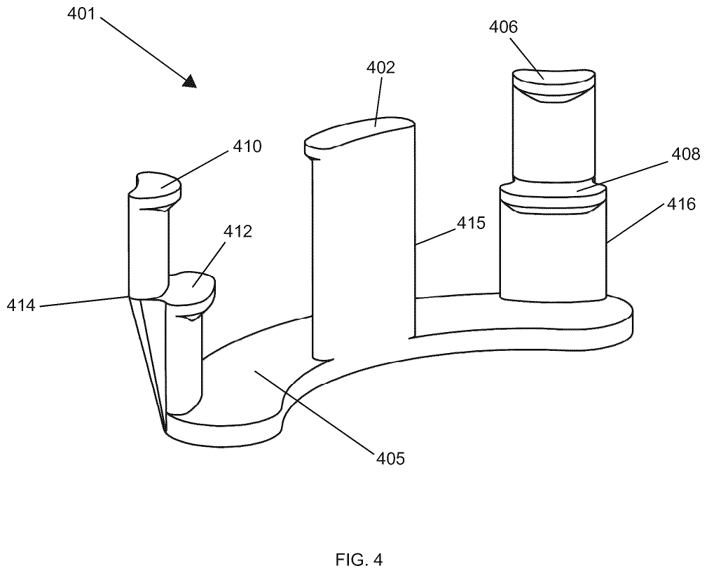

Any of first support arm 102, bar 107, and second support arm 106 of plant limb training apparatuses 101 may have overhangs at their distal ends to prevent plant limbs from sliding off. These overhangs may be similar to the overhangs shown in use with plant limb training apparatus 401 (FIG. 4-6). Any such overhangs for plant limb training apparatuses 101 may extend the circumference of first support arm 102, bar 107, and second support arm 106.

FIG. 4 illustrates a perspective back view of an alternate embodiment of plant limb training apparatus 401. Curved plate 405 is a substantially flat surface. First support arm 414, second support arm 415, and third support arm 416 are disposed on curved plate 405, such that first support arm 414, second support arm 415, and third support arm 416 extend outward from curved plate 405 at an approximately 90 degree angle.

First support arm 414 and third support arm 416 have at least one step that creates first ledge 412 and third ledge 408, respectively. The distal ends of first support arm 414, second support arm 415, and third support arm 416 respectively have first top ledge 410, second top ledge 402, and third top ledge 406. Second support arm 415 may have one or more steps, as desired. Although FIGS. 4-6 only show one step on each of first support arm 414 and third support arm 416, any number of steps may be on any of first support arm 414, second support arm 415, and third support arm 416. The steps, and in turn the first ledge 412 and third ledge 408, as well as any ledges that may be created with additional steps, may be any size or shape.

Each of first ledge 412, third ledge 408, first top ledge 410, second top ledge 402, and third top ledge 406 have an overhang that extends substantially parallel to curved plate 405.

First support arm 414 and third support arm 416 are located near the distal ends of curved plate 405, while second support arm 415 is located in between first support arm 414 and third support arm 416.

First ledge 412, first top ledge 410, third ledge 408, and third top ledge 406 are oriented such that they partially face second support arm 415.

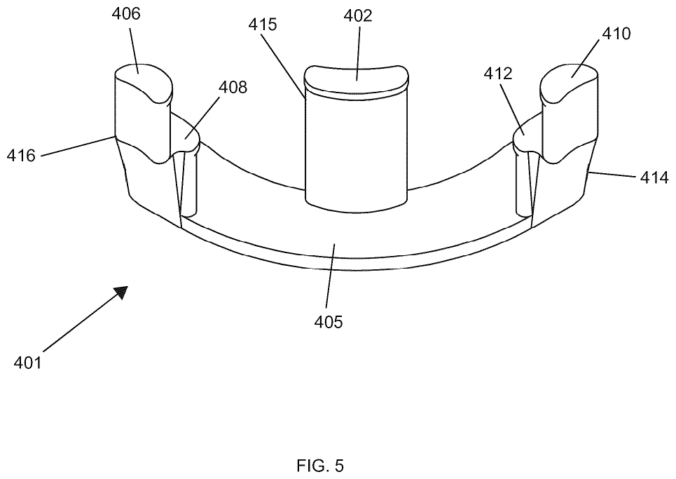

FIG. 5 illustrates a perspective front view of an alternate embodiment of plant limb training apparatus 401.

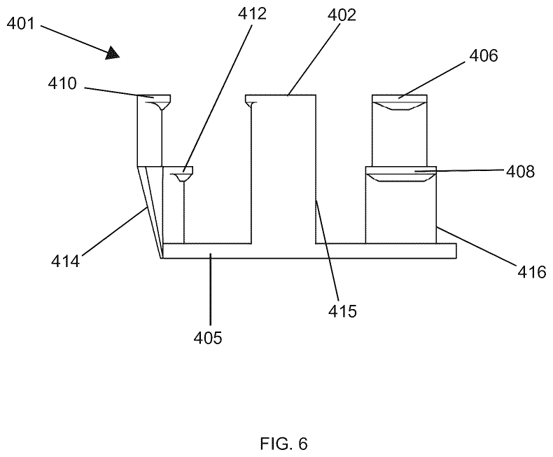

FIG. 6 illustrates a back side view of an alternate embodiment of plant limb training apparatus 401.

Curved plate 405 may comprise any shape, provided that the orientation of first support arm 414, second support arm 415, and third support arm 416 are disposed on the plate in substantially the same orientation as shown in FIGS. 4-6.

The various overhangs on first support arm 414, second support arm 415, and third support arm 416 are designed to prevent a limb from losing contact with first support arm 414, second support arm 415, and third support arm 416, when in use. Having steps on first support arm 414 and third support arm 416 allows for a larger range of motion when training limbs.

Any of the ledges, including first ledge 412, third ledge 408, and additional ledges that may be added, as well as the distal ends of any support arms may or may not have overhangs. These overhangs may be of any shape or size.

In order to use plant limb training apparatus 401, a plant limb is placed in direct contact with each of first support arm 414, second support arm 415, and third support arm 416 in such a manner that the plant limb slightly curves around second support arm 415. Depending on the amount of bend, or training, desired of the plant limb, the user can utilize the different positions that are created by the steps on first support arm 414 and third support arm 416. By placing the plant limb in contact with the lower steps of first support arm 414 and third support arm 416, a user will get a tighter bend, while the upper steps of first support arm 414 and third support arm 416 will provide a looser bend. Additionally, the lower step of first support arm 414 or third support arm 416 can be utilized while the upper step of the other support arm is utilized, thus offering a wider range of bend of tree limbs.

Ideally, the plant limb will be in contact with the front side of second support arm 415, as shown in FIG. 5. This allows the plant limb to generally follow the shape of plant limb training apparatus 401. However, the plant limb may be placed on the rear side of second support arm 415, if so desired.

While being used, plant limb training apparatus 101 and plant limb training apparatus 401 can be used on any number of plant limbs on a given plant. Plant limb training apparatus 101 and plant limb training apparatus 401 can be moved to different positions on a plant limb as desired, and any number of plant limb training apparatus 101 and/or plant limb training apparatus 401 may be utilized on one limb. Additionally, plant limb training apparatus 101 and plant limb training apparatus 401 may be used on the same plant.

The support arms may extend in any direction, or multiple directions, and may be any shape or size. Additionally, the support arms may be adjustable.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

What is claimed is:

1. A plant limb training apparatus, comprising:
a first plate,
wherein the first plate comprises a bar extending outward at a first fulcrum portion,
wherein the first plate comprises a first support arm extending outward near the distal end of the first plate,
wherein a pin is disposed on the first support arm extending partially toward the bar; and
a second plate,
wherein the second plate comprises a hole at a second fulcrum portion,
wherein the second plate comprises a second support arm extending outward near the distal end of the second plate,
wherein the rounded edge of the second plate near the second fulcrum portion comprises a partial gear, and
wherein the bar of the first plate is disposed in the hole of the second plate thus creating a fulcrum point at the first and second fulcrum portions, and the pin on the first support arm is substantially close to the partial gear of the second plate.

2. The plant limb training apparatus of claim 1, wherein one or more nubs are disposed on the bar on the first plate.

3. The plant limb training apparatus of claim 2, wherein the hole on the second plate comprises one or more notches in the shape of the one or more nubs on the bar on the first plate.

4. The plant limb training apparatus of claim 1, wherein the pin is configured to rotationally engage the partial gear.

5. The plant limb training apparatus of claim 1, wherein when the second plate is disposed on the first plate, the second plate rotates at the fulcrum point and is locked into place at each dedendum of the gear.

6. The plant limb training apparatus of claim 1, wherein one or more additional support arms are disposed on the first plate and/or the second plate.

7. The plant limb training apparatus of claim 1, wherein the first plate and the second plate are one solid piece.

8. The plant limb training apparatus of claim 1, wherein the bar and the first support arm each extend outward from the first plate at an approximately 90 degree angle, and the second support arm extends outward from the second plate at an approximately 90 degree angle.

9. A plant limb training apparatus, comprising:
a first plate and a second plate,
wherein the first plate contains a first support arm extending outward near the distal end of the first plate,
wherein the second plate contains a second support arm extending outward near the distal end of the second plate,
wherein the edge of the second plate near the fulcrum point comprises a partial rounded gear,
wherein the first plate and second plate are rotatably and axially connected at a fulcrum point,
wherein the first plate contains a pin disposed on the first support arm that extends partially toward the fulcrum point; and
wherein pin is substantially close to the partial gear of the second plate.

10. The plant limb training apparatus of claim 9, wherein one or more nubs are disposed on the bar on the first plate.

11. The plant limb training apparatus of claim 10, wherein the hole on the second plate comprises one or more notches in the shape of the one or more nubs.

12. The plant limb training apparatus of claim 9, wherein the pin is configured to rotationally engage the gear.

13. The plant limb training apparatus of claim 9, wherein when the second plate is disposed on the first plate, the second plate rotates at the fulcrum point and is locked into place at each dedendum of the gear.

14. The plant limb training apparatus of claim 9, wherein one or more additional support arms are disposed on the first plate and/or the second plate.

15. The plant limb training apparatus of claim 9, wherein the first plate and the second plate are one solid piece.

16. The plant limb training apparatus of claim 9, wherein the bar and the first support arm each extend outward from the first plate at an approximately 90 degree angle, and the second support arm extends outward from the second plate at an approximately 90 degree angle.

17. A plant limb training apparatus, comprising:
a curved plate with a flat surface;
a first support arm;
a second support arm; and
a third support arm,
wherein the first support arm, the second support arm, and the third support arm are disposed on the curved plate, with each support arm extending outward from the curved plate at an approximately 90 degree angle,
wherein the first support arm and the third support arm are located near the ends of the curved plate,
wherein the second support arm is located between the first support arm and the third support arm, and
wherein the first support arm and the third support arm each have at least one step that creates at least one ledge.

18. The plant limb training apparatus of claim 17, wherein the steps on the first support arm and the third support arm are oriented such that they partially face the second support arm.

19. The plant limb training apparatus of claim 17, wherein the first support arm, the second support arm, and the third support arm each have an overhang at the distal ends.

20. The plant limb training apparatus of claim 19, wherein the first support arm and the third support arm each have an overhang on the ledges of the steps.
